(19) United States
(12) Patent Application Publication
(10) Pub. No.: US 2018/0332557 A1
(43) Pub. Date: Nov. 15, 2018

(54) NEW ACCESS POINT SETUP

(71) Applicant: Facebook, Inc., Menlo Park, CA (US)

(72) Inventors: Lauri Vuornos, Palo Alto, CA (US); Murtadha Zuhair Sattar Al-Tameemi, Seattle, WA (US); Kevin Michael Hannan, San Mateo, CA (US)

(21) Appl. No.: 15/595,682

(22) Filed: May 15, 2017

(51) Int. Cl. H04W 64/00; H04W 48/20

(52) U.S. Cl. CPC H04W 64/006; H04W 24/04; H04W 48/20

(57) ABSTRACT

Techniques for providing Internet service to consumers using wireless access points are presented. A technician app provides, through a user interface of a mobile device, instructions for selecting one or more available devices for an access point at a geographic location, directions to the geographic location, instructions for installing and configuring the selected devices for the access point, and instructions for collecting information regarding the geographic location. A consumer app provides, to a potential consumer using a mobile device, a list of available access points to the Internet. The consumer app determines a geographic location associated with an access point selected by the potential consumer, provides guidance to the potential consumer to travel to the geographic location, and provides instructions to the potential consumer for purchasing Internet service at the geographic location to use the access point for accessing the Internet.

### BACKGROUND

Internet access has changed the way in which many people think, and has become an integral part of people's economic, political, and social lives. Providing Internet access to more people in the world will allow them to take advantage of the political, social, economic, educational, and career opportunities available over the Internet. Despite tremendous growth, Internet access is still not widely available in many places, and certainly not distributed equally within or between countries. For example, one of the great challenges for Internet access in general, and for broadband access in particular, is to provide Internet service to potential consumers in areas of low population density, areas with hilly and heavily foliated terrain, or areas with underdeveloped economies.

### SUMMARY

The present disclosure generally relates to app-guided wireless Internet access point (AP) installation, maintenance, expansion, and awareness. More specifically, techniques described herein enable different entities, such as Internet service provider (ISP) technicians, retailers of the Internet service, or Internet service consumers, to install, maintain, commercialize, or utilize wireless local area network (WLAN) APs, such as Wi-Fi APs.

In certain embodiments, a method of providing Internet service is provided. The method may include providing, through a user interface of a mobile device, instructions for selecting one or more available devices for an access point to be installed at a geographic location, directions to the geographic location, instructions for installing and configuring the selected one or more available devices for the access point, and instructions for collecting information regarding the geographic location. In some embodiments, the method may further include providing, through the user interface, instructions for saving the information regarding the geographic location to a database. In some embodiments, the method may further include providing, through the user interface, instructions for associating the access point with a hotspot.

In some embodiments of the method for providing Internet service, providing the instructions for collecting the information regarding the geographic location may include providing instructions for taking pictures of the selected one or more available devices for the access point after installing and configuring the selected one or more available devices. The instructions for collecting the information regarding the geographic location may also include instructions for performing at least one of taking one or more pictures of surroundings of the geographic location, taking one or more videos of the surroundings of the geographic location, or measuring a three dimensional map of the surroundings of the geographic location. In some embodiments, providing the instructions for collecting the information regarding the geographic location may also include providing instructions to an Internet service provider personnel or an Internet service retailer for determining coordinates or an address of the geographic location, and/or associating the access point with a map based on the coordinates or address of the geographic location. In various embodiments, the geographic location may be the same as or different from a physical location of the access point. The instructions may be provided to an Internet service provider personnel or an Internet service retailer using an application or a web browser.

In some embodiments of the method for providing Internet service, providing the instructions for collecting the information regarding the geographic location may also include providing instructions for measuring one or more wireless signal parameters at a plurality of grid points at the geographic location. The one or more wireless signal parameters may include at least one of a signal strength, a round trip time between a grid point and the access point, an interference level, a data transfer rate, a latency for loading a web page, a data error rate, or a packet drop rate. The instructions for measuring the one or more wireless signal parameters may be provided to at least one of an Internet service provider personnel, an Internet service retailer, or one or more consumers.

In some embodiments, the method for providing Internet service may further include determining at least one candidate location for setting up a new access point, based on the information regarding the geographic location. In some embodiments, determining the at least one candidate location for setting up the new access point may be based on the one or more wireless signal parameters at the plurality of grid points.

In certain embodiments, a method of providing Internet service may include providing, through a user interface of a mobile device to a potential consumer, a list of one or more access points to the Internet. The method may also include determining a geographic location associated with an access point selected by the potential consumer from the list of one or more access points, and providing, through the user interface and based on information regarding the geographic location stored in a database, directions to the geographic location. The method may further include providing, through the user interface, instructions for purchasing Internet service at the geographic location to use the access point for accessing the Internet.

In some embodiments of the method of providing Internet service, the information regarding the geographic location may include one or more pictures of surroundings of the geographic location, one or more videos of the surroundings of the geographic location, a three dimensional map of the surroundings of the geographic location, coordinates or an address of the geographic location, or any combination thereof. In some embodiments, the information regarding the geographic location may be collected by an Internet service provider personnel or an Internet service retailer using an application or a web browser. In some embodiments, the method may further include providing, through the user interface, instructions for measuring one or more wireless signal parameters at a plurality of grid points at the geographic location, wherein the one or more wireless signal parameters may include at least one of a signal strength, a signal round trip time between a grid point and the selected access point, an interference level, a data transfer rate, a latency for loading a web page, a data error rate, or a packet drop rate.

In certain embodiments, a system may include one or more processors, a user interface, and a non-transitory computer-readable medium storing instructions. The instructions, when executed by the one or more processors, may cause the one or more processors to provide, through the user interface, instructions for selecting one or more available devices for an access point at a geographic location, directions to the geographic location, instructions for installing and configuring the selected one or more available devices for the access point, and instructions for collecting information regarding the geographic location. In some embodiments, the information regarding the geographic location may include one or more pictures of surroundings of the geographic location, one or more videos of the surroundings of the geographic location, a three dimensional map of the surroundings of the geographic location, coordinates or an address of the geographic location, one or more wireless signal parameters at a plurality of grid points at the geographic location, or any combination thereof.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures:

FIG. 1 is a simplified illustration of an example wireless communication system, according to certain aspects of the present disclosure;

FIG. 2 is a simplified block diagram showing an example system for wireless Internet access point (AP) installation, maintenance, and usage, according to certain aspects of the present disclosure;

FIG. 3 is a simplified flow chart illustrating a method of setting up a new wireless Internet access point, according to certain aspects of the present disclosure;

FIG. 4 illustrates an example heat map indicating wireless signal strength measured in an area, according to certain aspects of the present disclosure;

FIG. 5 is a simplified flow chart illustrating a method of monitoring and maintaining a wireless Internet access point by a retailer, according to certain aspects of the present disclosure;

FIG. 6 is a simplified flow chart illustrating a method of wireless Internet access by a consumer, according to certain aspects of the present disclosure;

FIG. 7 is a simplified block diagram of an example computer system for implementing some of the examples disclosed herein; and

FIG. 8 is a simplified block diagram of an example mobile device for implementing some of the examples disclosed herein.

### DETAILED DESCRIPTION

In the following description, for the purposes of explanation, specific details are set forth in order to provide a thorough understanding of examples of the disclosure. However, it will be apparent that various examples may be practiced without these specific details. For example, devices, systems, networks, processes, and other components may be shown as components in block diagram form in order to not obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof.

Techniques disclosed herein enable different entities, such as Internet service provider (ISP) technicians, retailers of the Internet service, or consumers of Internet service, to install, maintain, commercialize, or utilize a wireless local area network (WLAN) access point (AP), such as a Wi-Fi AP. As used herein, any component that can connect to a wireless medium in a network may be referred to as a wireless station (STA). A wireless station may be equipped with a wireless network interface controller (WNIC). The wireless stations of a network may include wireless APs and wireless clients. Wireless APs, which generally refer to hardware devices used to provide a wireless network service, such as wireless routers or wireless bridges, may be the base stations for the wireless network. Wireless APs may transmit and receive radio frequency (RF) signals for wireless enabled devices to communicate with the Internet. Wireless clients may include mobile devices, such as laptops, personal digital assistants, Internet protocol (IP) phones and other smartphones, or non-portable devices such as desktop computers and workstations that are equipped with a wireless network interface.

As used herein, a hotspot may refer to a physical location where consumers may obtain Internet access using, for example, Wi-Fi technology, and through a router connected via a WLAN to an Internet service provider. For example, public hotspots may be found in a number of businesses in many developed urban areas throughout the world.

As also used herein, an app refers to an application software designed to run on, for example, computers or mobile devices, such as smartphones, laptop computers, and tablet computers. An app may usually be a mobile application software or mobile app that can be installed and accessed on a mobile device. As used herein, technician app generally refers to an app that an Internet service provider technician would access using his/her mobile device. A retailer app generally refers to an app that an Internet service retailer would access using the retailer's device, such as a computer or a mobile device. A consumer app refers to an app that an Internet service consumer would access using his/her computer or mobile device.

According to certain embodiments, when a new AP is to be set up for a Wi-Fi hotspot at a selected geographic location, a technician app running on a mobile device may guide an ISP technician to select the appropriate devices, find the selected geographic location, install the devices, take pictures (or videos) of the installed devices and the surrounding area of the AP, record the location associated with the AP (e.g., using a global positioning system (GPS) device on the mobile device), and associate the AP with the hotspot. The location associated with the AP may be the location of the AP or a location where a potential consumer may purchase or use Internet service provided through the AP, such as, for example, 20 feet or 50 feet away from the location of the AP. The pictures of the installed devices and the surrounding area of the AP may be used by a technician to locate a specific device that may need repair, replacement, or upgrade at a future time. The pictures of the surrounding area of the AP may include pictures for a 360 degree of view. In addition, the pictures of the surrounding area of the AP and the recorded location associated with the AP may be added to maps, such as Google Maps, such that a potential consumer could search for APs using the maps, learn about the surrounding area of an AP, and locate a selected AP. The technician app may also guide the technician to measure coverage information, such as signal strength (e.g., received signal strength indicator (RSSI)), interference, available bandwidth, or data rate, at different grid points in the surrounding area of the AP. The measured coverage information may be used, for example, to generate a wireless signal heat map for the surrounding area. In some cases, the technician app may also guide the technician to measure the surrounding area using, for example, a light detection and ranging (LIDAR) or laser detection and ranging (LADAR) system or a 3-D camera, to generate a 3-D map of the surrounding area. The technician app may also guide the technician to record the location of a retailer associated with the AP and take pictures or videos inside and/or outside the retailer's facility, which may also be added to maps, such as Google Maps, and may be searchable by a potential consumer to locate a nearby retailer.

Additionally or alternatively, a retailer app may guide a retailer to record the location of the retailer and take pictures or videos inside and/or outside the retailer's facility. The retailer app may also guide the retailer to measure the coverage information at different grid points in the area surrounding an AP. The coverage information may be measured by the retailer after the AP is installed. The coverage information may also be measured by the retailer periodically, or when an abnormal event, such as a low data rate, a high drop rate, or a weak signal strength, is detected by the AP or consumer devices.

A consumer app may be installed on a consumer mobile device, and may be used to guide the potential consumer to find a nearby AP (or hotspot), locate the AP and the associated retailer, and purchase and use Wi-Fi service through the AP. In some implementations, the consumer app may also provide instructions for measuring coverage information at different grid points in the surrounding area of the AP by a consumer device.

The coverage information, pictures (or videos), and/or the 3-D map of the surrounding areas of different APs collected using the technician app, the consumer app, and/or the retailer app may be crowdsourced for use in identifying candidate locations for installing new APs for coverage expansion. For example, a location may be identified as a candidate location if the measured Wi-Fi signal strength is weak at the location, the measured interference from other radio frequency (RF) signals is low at the location, the location is easily accessible, and the surrounding area (e.g., within 100 or 50 meters) is clear of buildings or other obstacles.

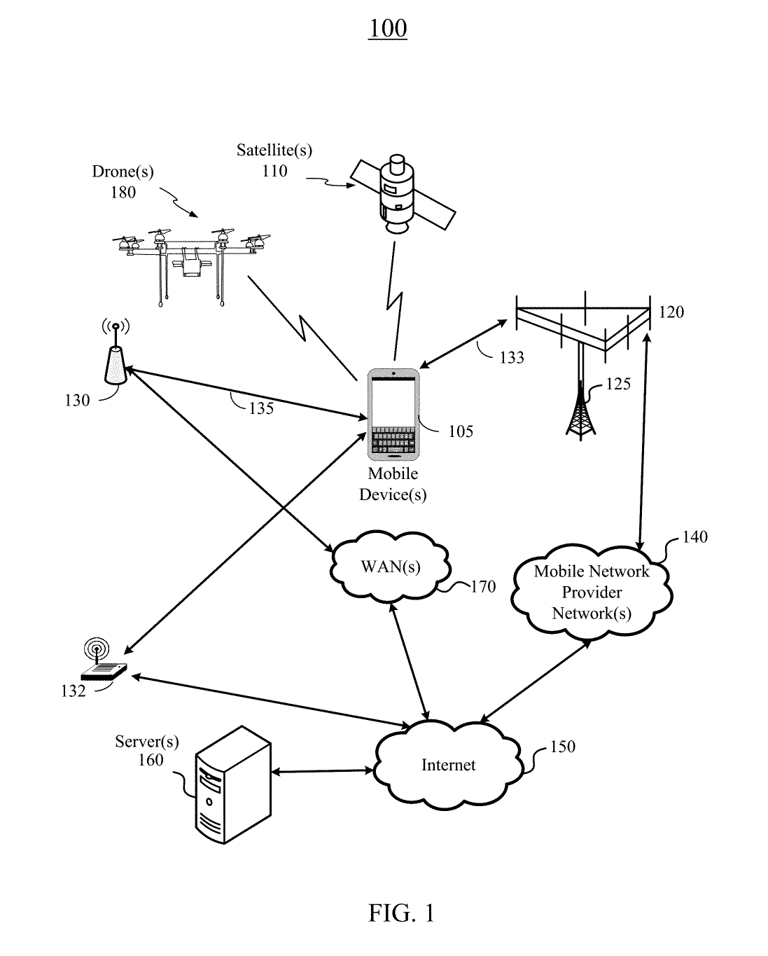

FIG. 1 is a simplified illustration of an example wireless communication system 100, according to certain aspects of the present disclosure, which may be used to implement various techniques described herein. The components presented in FIG. 1 and described below are intended to be illustrative and non-limiting. Wireless communication system 100 may include at least some of one or more mobile devices 105, one or more satellites 110, one or more base transceiver stations 120, one or more mobile network provider's networks 140, one or more WLAN access points 130, one or more small cell access points 134, one or more servers 160, one or more wireless area networks (WANs) 170, and one or more AP-equipped drones 180. These components of wireless communication system 100 may be connected directly or indirectly to the Internet 150. Mobile device(s) 105 may communicate with other constituents of wireless communication system 100, such as server(s) 160. It should be noted that FIG. 1 provides only a generalized illustration of various components, any or all of which may be utilized as appropriate, and each of which may be duplicated as appropriate. Specifically, although only one mobile device 105 is illustrated, it will be understood that many mobile devices (e.g., hundreds, thousands, or more) may be utilized in wireless communication system 100. Similarly, wireless communication system 100 may include many base transceiver stations (similar to base transceiver station(s) 120) and/or a larger or smaller number of APs 130. Connections between illustrated components may include additional (intermediary) components, direct or indirect connections, and/or additional networks. Furthermore, components may be rearranged, combined, separated, substituted, and/or omitted, depending on desired functionality. A person of ordinary skill in the art will recognize many modifications to the components illustrated.

As shown in FIG. 1, there may be a plurality of WLAN APs 130, some or all of which may be detected by mobile device(s) 105. Although FIG. 1 shows a mobile device 105 having a communication link (communication link 135) with only one WLAN AP 130, other configurations or embodiments may allow for multiple communication links with multiple WLAN APs, such as WLAN AP(s) 130. Additionally or alternatively, a mobile device 105 may establish communication links with different APs at different times.

In some implementations, satellite(s) 110, AP-equipped drone(s) 180, or other airborne Internet access points (e.g., an AP-equipped hot air balloon) may be used to provide Internet service to, for example, rural areas, outdoor areas, remote areas, or areas that may have many obstacles on the ground. In some implementations, satellite(s) 110 may also be used as Standard Positioning Service (SPS) satellites for determining a position of a mobile device.

Base transceiver station(s) 120 may include one or more antennas installed on an antenna supporting structure 125 for communicating with mobile device(s) 105. Base transceiver station(s) 120 may also be communicatively coupled to mobile network provider's network(s) 140 (e.g., a cellular network), which may be communicatively coupled with the Internet 150. In some cases, there may be dead zones or zones with poor wireless signal reception in a wireless communication network of a service provider, such as, for example, areas between base transceiver station(s) 120 and/or access points, or areas too far from a base transceiver station or access point. Small cells, such as microcells, picocells, or femtocells, may be used to extend the service coverage to these zones where access to the wireless communication network would otherwise be limited or unavailable. One or more small cell access points 132 may be added in such areas to improve the quality of services in these areas. The small cells may be connected to the Internet 150 via broadband Internet access, allowing mobile devices in these areas to access the Internet 150 and/or mobile network provider network(s) 140.

Server(s) 160 may include, for example, one or more authentication servers and/or file servers, and may be communicatively coupled with the Internet 150. Thus, mobile device(s) 105 can communicate information with the server(s) 160, for example, by accessing the Internet 150 via the base transceiver station(s) 120 using a communication link 133. Additionally or alternatively, because AP(s) 130 and WAN(s) 170 may also be communicatively coupled with the Internet 150, mobile device(s) 105 may communicate with server(s) 160 using communication link 135 through an AP 130 and the Internet 150.

Techniques described herein can utilize server(s) 160 to receive “crowdsourced” information from one or more mobile devices regarding one or more APs 130 and/or one or more base transceiver stations (similar to base transceiver station(s) 120). Server(s) 160 may gather information from a plurality of mobile devices and use the gathered information to determine, for example, whether an access point is functioning properly, where a new access point should be set up in a certain area. In some embodiments, the information may include received signal strength indicator (RSSI) and/or round trip time (RTT) measurements for each AP or each base receiver station, line of sight in the surrounding area of the AP, radio frequency interference in an area, data transfer rate and latency, communication bandwidth, etc. For example, in some embodiments, the information may include the time it takes to load a web page, or the time it takes to download a file of a certain size.

As discussed above, in certain areas, such as areas of low population density, areas with hilly and heavily foliated terrain, or areas with underdeveloped economy, Internet access may be unavailable or may be limited. For example, the signal strength or data communication bandwidth in these areas may be limited. To improve the Internet accessibility in an area, new access points, such as WLAN access points (e.g., Wi-Fi access points), may need to be installed and maintained by a wireless Internet service provider. A wireless Internet service provider may be an Internet service provider with a network based on wireless networking. Technology for wireless networking may include Wi-Fi wireless mesh networking, or wireless networking using proprietary equipment designed to operate over open 900 MHz, 2.4, 4.9, 5, 24, or 60 GHz bands, or licensed frequencies in the ultra-high frequency (UHF) band, Local Multipoint Distribution Service (LMDS) band, and other bands from 6 GHz to 80 GHz. A wireless Internet service provider may be a cellular communication service provider (i.e., cellular phone carrier), or may be an entity other than a cellular communication service provider. In some cases, the wireless Internet service provider may sell the Internet service to consumers directly. In some cases, an Internet service retailer, such as an owner of a hot spot, may help to maintain an access point and sell the Internet service provided by the wireless Internet service provider to consumers. Consumers may purchase Internet access service from the wireless Internet server provider or the retailer when needed in order to use a nearby access point for Internet access.

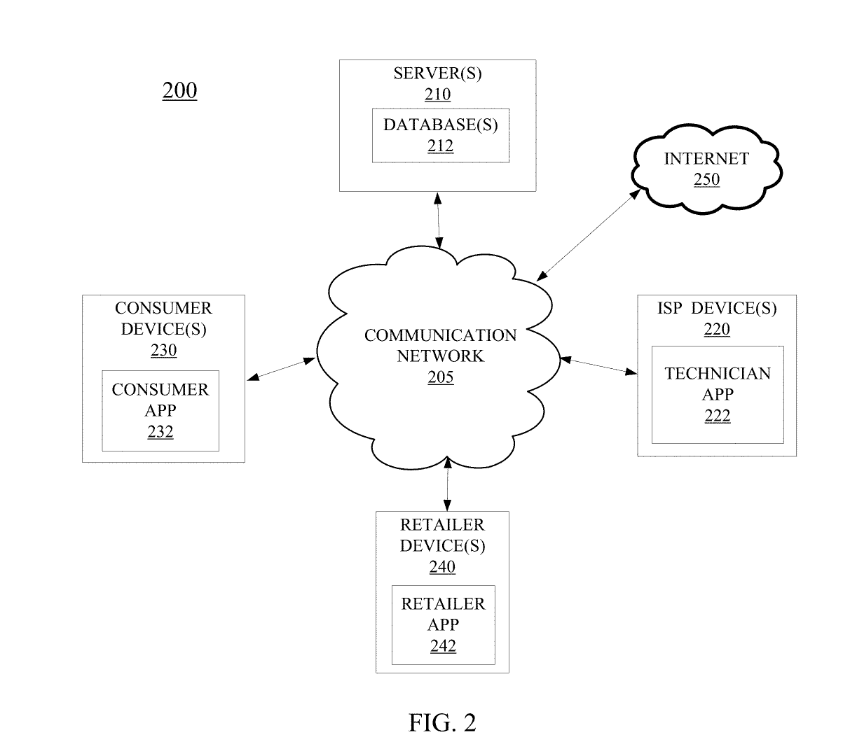

FIG. 2 is a simplified block diagram showing an example system 200 for wireless Internet access point (AP) installation, maintenance, and usage, according to certain aspects of the present disclosure. As shown in FIG. 2, system 200 may include one or more servers 210 from one or more ISPs, one or more ISP devices 220 that may be used by technicians or other personnel of an ISP, and one or more consumer devices 230, where ISP device(s) 220 and consumer device(s) 230 may be connected to server(s) 210 through a communication network 205 provided by the ISP. Communication network 205 may be connected to the Internet 250. In some implementations, system 200 may also include one or more retailer devices 240 that can be connected to server(s) 210 through communication network 205.

As described above with respect to wireless communication system 100, communication network 205 may include various wireless Internet access points, such as WLAN access point(s) 130, satellite(s) 110, and drone(s) 180, which may be connected to Internet 250 directly or indirectly through one or more servers or networks, and provide Internet access to consumers.

Server(s) 210 may include, for example, one or more authentication servers, file servers, domain name servers, etc. Server(s) 210 may include or be connected to one or more databases 212, which may store information regarding various access points and/or hotspots, such as identifications of the access points, locations of the access points, lists of devices (and identifications of the device) used in each access point, photos or videos of areas surrounding the access points, coverage information (e.g., a heat map) of the access points, operators/retailers of the access points, etc. The information regarding the various access points and hotspots may include information collected by one or more ISP devices 220, consumer devices 230, and/or retailer devices 240.

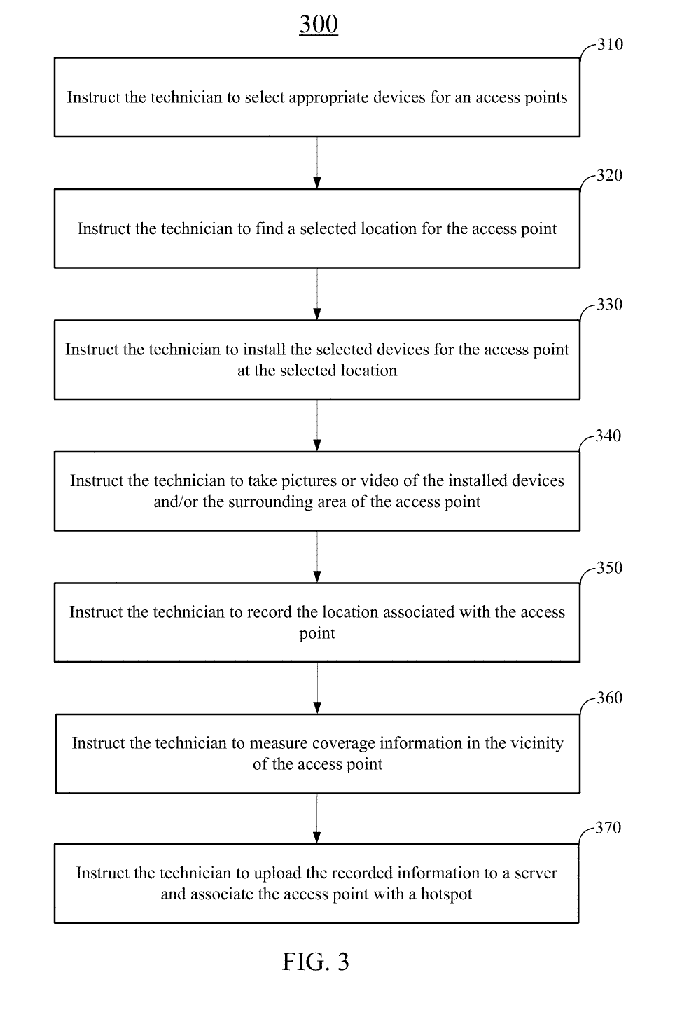

ISP device(s) 220 may include a mobile device, such as a laptop, personal digital assistant, IP phone and other smartphone, tablet, or a special purpose mobile device, that is equipped with a wireless network interface, and may be used by technicians or other personnel of the ISP to set up or maintain a wireless access point. One or more technician apps may be executed on ISP device(s) 220 to assist or guide the technicians or other ISP to select appropriate devices, find a selected location, install the devices at the selected location, take pictures (or videos) of the installed devices and the surrounding area of the AP, record the location associated with the AP (e.g., using GPS on the mobile device), and associate the AP with the hotspot. Details of the technician app are described below, for example, with respect to FIG. 3.

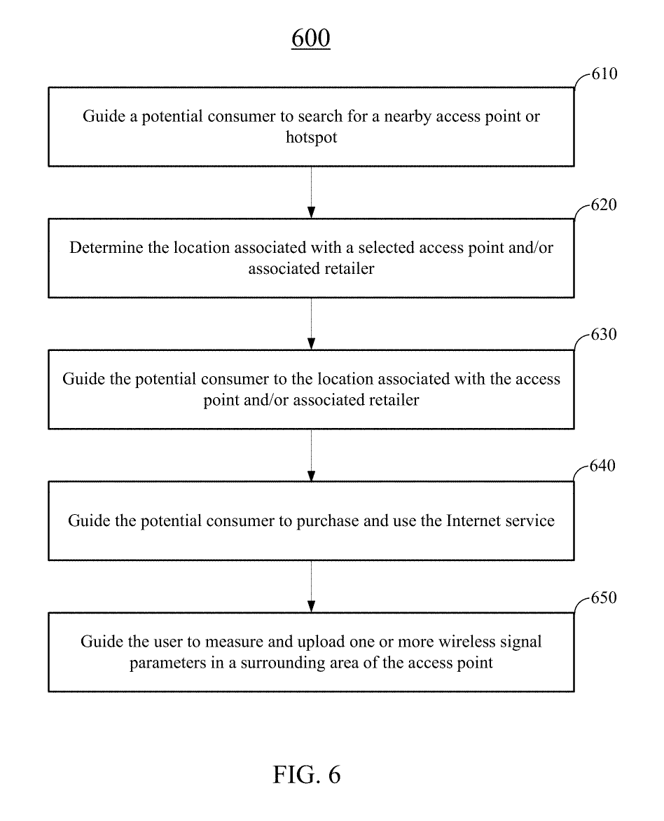

Consumer device(s) 230 may also include a mobile device, such as a laptop, personal digital assistant, IP phone and other smartphone, tablet, or a non-portable device such as a desktop computer or workstation, that is equipped with a wireless network interface. One or more consumer apps may be executed on consumer device(s) 230 to assist or guide the potential consumers to search for a nearby hotspot, locate the hotspot, purchase the Internet access service from a wireless ISP or a retailer, and use the Internet access service at the hotspot. Details of the consumer app are described below, for example, with respect to FIG. 6.

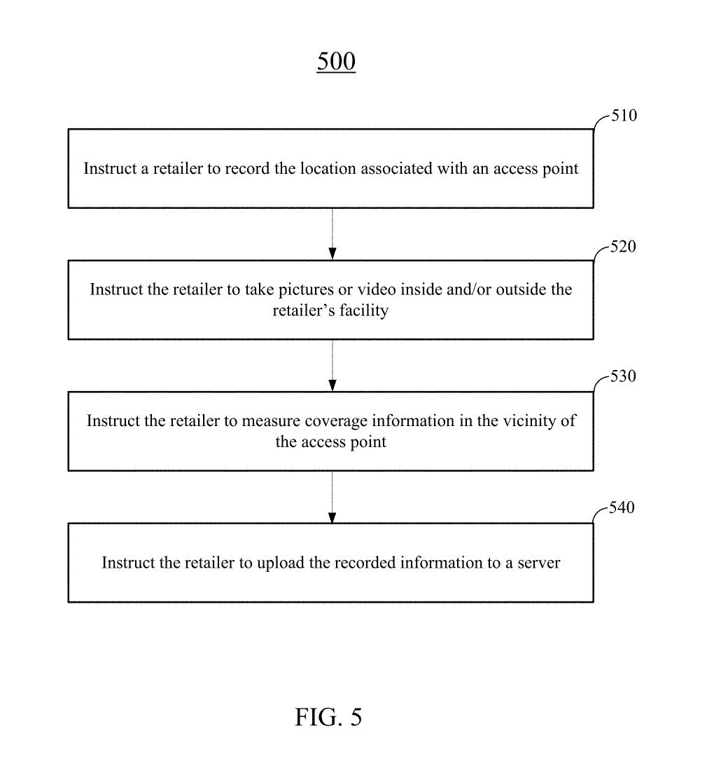

In implementations where the wireless Internet service is sold by a retailer, retailer device(s) 240 may be used for monitoring and maintaining the access points, and/or providing customer service to consumers. Retailer device(s) 240 may include a mobile device, such as a laptop, personal digital assistant, IP phone and other smartphone, tablet, or a non-portable device such as a desktop computer or workstation, that is equipped with a wired or wireless network interface. One or more retailer apps may be executed on retailer device(s) 240 to assist or guide the retailers to gather information regarding the retailer's facility, monitor the performance of the access points, and provide collected information to a server, such as a crowdsource server. Details of the consumer app are described below, for example, with respect to FIG. 5.

FIG. 3 is a simplified flow chart 300 illustrating a method of setting up a new wireless Internet access point, according to certain aspects of the present disclosure. The method may be implemented as an application program, such as a technician app that can be executed on a mobile device, or a web-based application that runs on a remote server and can be accessed through a user interface (e.g., a web browser). The technician app may guide a technician or other ISP personnel to select the appropriate devices for an access point at a hotspot, find the selected location for the hotspot, install, configure, and verify the devices for the access point, take pictures, videos, or 3-dimensional measurements of the installed devices and the surrounding area of the AP, record the location associated with the AP the AP (e.g., using a GPS device on the mobile device), and associate the AP with the hotspot in a database. As described above, the location associated with the AP may be the location of the AP or a location where a potential consumer may purchase or use Internet service provided through the AP.

At 310, the application program may instruct the technician to select the appropriate devices for an access points. The devices for an access point may be determined based on, for example, the technology and frequency band used by the wireless ISP, the desired range of coverage of the access point, the desired aggregated bandwidth for the access point, the geographic location where the access point is to be installed, etc. The application program may provide a list and corresponding models of the devices needed for the access point, such that the technician can pick the appropriate devices. In some cases, the application program may provide the serial numbers of the devices to use based on available devices in the inventory, or record the serial numbers of the devices selected by the technician.

At 320, the application program may instruct the technician to find the selected location for the access point. Based on the desired location of the hotspot, the application program may provide the technician with directions to the selected location for the access point, for example, using a global navigation satellite system (GNSS) device (e.g., a GPS device) on the mobile device used by the technician. The selected location may be represented by, for example, geodetic latitude, longitude, and altitude (LLA) coordinates, xyz coordinates, Earth-Centered Inertial (ECI) coordinates, Earth-Centered-Earth-Fixed (ECEF) coordinates, or the street address. In some cases, the application program may select a specific location for installing the access point at the hotspot. In some cases, the technician may select the specific location for installing the access point at the hotspot based on the surrounding environment at the hotspot (e.g., obstacles, line-of-sight coverage, etc.).

At 330, the application program may instruct the technician to install the devices for the access point at the selected location. The instructions may include the procedure or sequence of installing, connecting, and powering up different devices, the detailed configuration of each device, the procedure of testing and verifying the functionality of the devices, etc. A unique identification may be assigned to the access point after it has been set up.

At 340, the application program may instruct the technician to take pictures or videos of the installed devices and/or the surrounding area of the access point. The pictures and/or videos may be taken by a camera on the mobile device, or by a stand-alone camera. The pictures or videos of the installed devices may show how the devices are installed and connected, which may be used, for example, for future maintenance, replacement, or upgrade of the devices. The pictures or videos of the surrounding area of the access point may be taken at different points in the surrounding area, and may include, for example, a 360° view at a given point. In some cases, the technician may use, for example, a 3-D camera, or a portable LIDAR or LADAR system, to create a 3-D map or profile of the surrounding area. The pictures or videos of the surrounding area of the access point may be used by ISP personnel for future maintenance, replacement, or upgrade of the devices, or may be used for selecting a possible location for a new access point. The pictures or videos of the surrounding area of the access point may also be used by a potential consumer to locate the hotspot.

Optionally, at 350, if the specific location associated with the access point is unknown or undetermined before the installation, the application program may instruct the technician to record the location associated with the access point, using, for example, a GPS device. As described above, the specific location associated with the access point may be represented by, for example, LLA coordinates, xyz coordinates, ECI coordinates, ECEF coordinates, etc. The measured location associated with the access point may be added to a wireless Internet access coverage map, or a third-party map (e.g., Google Map), which may be used by a potential consumer to search for APs using the map, learn about the surroundings of an AP, and locate a selected AP.

At 360, the application program may instruct the technician to measure the coverage information in the vicinity of the access point at different grid points. The technician may measure the coverage information using a mobile device with an RF receiver while traveling from one grid point to another. The coverage information may include, for example, RSSI, interference levels at different frequency bands, available bandwidth, data rate, latency, etc., at different grid points in the surrounding area. The measured coverage information may be used, for example, to generate a wireless signal heat map for the surrounding area, or to determine whether and where a new access point would be installed in the surrounding area.

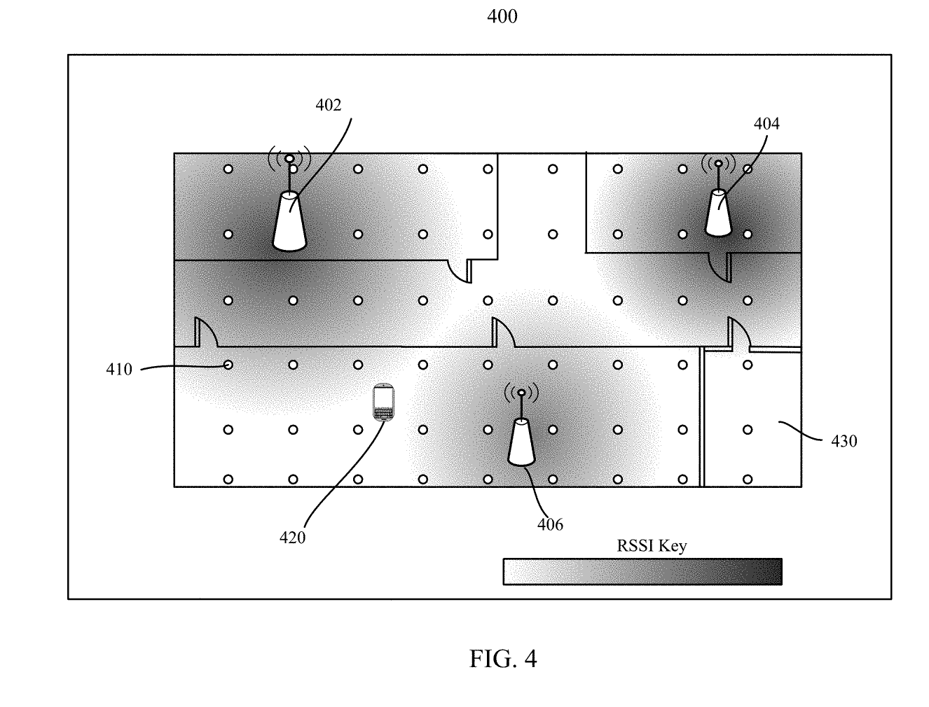

FIG. 4 illustrates an example heat map 400 indicating wireless signal strength measured in an area, according to certain aspects of the present disclosure. Heat map 400 of FIG. 4 illustrates the strength of signals generated by APs 402-406 as measured (or otherwise determined) at multiple grid points, where the signal strength (e.g., RSSI) is indicated by different gray-scale levels. Heat map information corresponding to signal sources, such as APs 402-406 may be collected using different techniques. For example, a dedicated device (e.g., a mobile device used by ISP personnel) may be used to measure signal strength at multiple locations within an environment. The locations may be regularly spaced grid points, such as grid points that are two feet or more apart. At a location, such as a grid point 410, the dedicated device may send, for each signal source, the measured signal strength data (e.g., RSSI of a beacon signal) and signal source identifier (e.g., MAC address) to a server, such as a server 160 of FIG. 1. The server may store the heat map for various applications. In some embodiments, the server may send heat map data to a mobile device, such as mobile device 420, for use by mobile device 420 to, for example, determine its own location and/or choose a location where the wireless signal is stronger.

In some embodiments, a crowd-sourcing scheme may be used to generate heat map information. For example, a plurality of mobile devices 420 may participate in crowd sourcing. The participating mobile devices may receive and/or observe position data, such as RSSI and/or RTT, from signal sources such as APs 402-406. The participating mobile devices may transmit the position data to server(s) 160 or 210. Server(s) 160 or 210 may use the received position data to generate a heat map. For example, server(s) 160 or 210 may determine an estimated signal strength corresponding to each signal source at multiple locations (e.g., multiple regularly-spaced grid points 410) in an environment.

Referring back to FIG. 3, at 370, the application program may instruct the technician to upload the recorded information to a server, such as server(s) 160 or 210, and associate the access point with the hotspot. The recorded information and the association of the access point with the hotspot may be saved to different databases for use by different entities. For example, the geographic location associated with the access point may be added to Google Maps or other maps, and the heat map may be added to a coverage map for a large area.

It is noted that even though FIG. 3 describes the operations as sequential processes, many of the operations can be performed in parallel or concurrently. In addition, the order of the operations may be rearranged. For example, operations at 340, 350, and 360 may be performed in any order or in parallel. An operation may have additional steps not included in the figure. Some operations may be optional, and thus may be omitted in various embodiments. For example, operations at 350 may be omitted if the geographic location associated with the access point is known before the installation. Operations at 340 and 360 may be omitted if the measurements and photo/video recording can be performed by other entities, such as a retailer or consumers. Some operations described in one block may be performed together with operations at another block. For example, operations at 340 and 360 may be performed together at any grid point while the technician travels from one grid point to another grid point around the access point. Furthermore, embodiments of the methods may be implemented in hardware, software, firmware, middleware, microcode, hardware description languages, or any combination thereof.

In many cases, the access point may be installed at, for example, a shop, a store, a restaurant, a hotel, or other facilities owned by a third party, and the hotspot may be operated by a retailer, such as an owner or tenant of the facility. The retailer may be under contract or agreement with the wireless ISP to maintain the access point and monitor the performance of the access point. As described above, in some implementations, the retailer may perform these functions with guidance or instructions from a retailer app. In some cases, wired Internet access service may also be provided at the hotspot.

FIG. 5 is a simplified flowchart 500 illustrating a method of monitoring and maintaining a wireless Internet access point by a retailer, according to certain aspects of the present disclosure. The method may be implemented as an application program, such as a retailer app that can be executed on a computing device (e.g., a desktop computer or a mobile device), or a web-based application that runs on a remote server and can be accessed through a user interface (e.g., a web browser).

At 510, if the geographic location associated with the access point is unknown yet or is not in the database, the application program may instruct the retailer to record the location associated with the access point using, for example, a GPS device. As described above, the location associated with the access point may be represented by, for example, LLA coordinates, xyz coordinates, ECI coordinates, ECEF coordinates, etc. The location associated with the AP may be the location of the AP or a location where a potential consumer may purchase or use Internet service provided through the AP. In some embodiments, the location associated with the access point may be represented by the street address of the retailer's facility. The measured location associated with the access point may be added to a wireless Internet access coverage map, or a third-party map (e.g., Google Map), which may be used by a potential consumer to search for APs using the map, learn about the surroundings of a AP, and locate a selected AP.

At 520, the application program may instruct the retailer to take pictures or videos inside and/or outside the retailer's facility. The pictures or videos of the surroundings of the access point may be taken at different locations in the surrounding area, and may include, for example, a 360° view at a given spot. In some cases, the retailer may use, for example, a 3-D camera, or a portable LIDAR or LADAR system, to create a 3-D map or profile of the surrounding area. The pictures, videos, and/or 3-D map of the surroundings of the access point may be used by ISP personnel for future maintenance, replacement, or upgrade of the devices, or for selecting a possible location for a new access point. The pictures or videos of the surrounding area of the access point may also be used by a potential consumer to locate the hotspot.

At 530, the application program may instruct the retailer to measure the coverage information in the vicinity of the access point at different grid points. The retailer may measure the coverage information using a mobile device with an RF receiver while traveling from one grid point to another. The coverage information may include, for example, RSSI, interference levels at different frequency bands, available bandwidth, data rate, latency, etc., at different grid points in the surrounding area. The measured coverage information may be used, for example, to generate a wireless signal heat map for the surrounding area, or to determine whether and where a new access point should be installed in the surrounding area. In some cases, the retailer may measure the coverage information periodically, such as every week or every month. In some cases, the retailer may measure the coverage information when, for example, an abnormal event, such as a low data rate, high drop rate, or weak signal strength, is detected by the AP or consumer devices.

At 540, the application program may instruct the retailer to upload the recorded information to a server, such as server(s) 210 of FIG. 2. The recorded information of the access point may be saved to different databases for use by different entities. For example, the location associated with the access point may be added to Google Maps or other maps, and the heat map may be added to a coverage map for a large area.

After an access point is set up and ready for use by consumers, the access point may be added to a database and become searchable by a potential consumer. The potential consumer may search for nearby access points and select an access point to use, using a consumer app or a web browser running on a consumer device. In some embodiments, the consumer app or other apps on the consumer device may automatically detect a nearby access point or hotspot. The consumer app running on a consumer device may guide the consumer to the hotspot, locate the retailer at the retailer's facility, and purchase the Internet service from the retailer. In some cases, under a contract or agreement, the consumer may help to collect coverage information of the access point, and the coverage information collected by one or more consumers at different grid points may be crowdsourced for determining the coverage in the surrounding area of the access point.

FIG. 6 is a simplified flow chart 600 illustrating a method of wireless Internet access by a potential consumer, according to certain aspects of the present disclosure. The method illustrated in flow chart 600 may be implemented as an application program, such as a consumer app that can be executed on a consumer device (e.g., a smartphone, a laptop, or a tablet), or a web-based application that runs on a remote server and can be accessed through a user interface (e.g., a web browser) on the consumer device.

At 610, the application program may guide a potential consumer to search for a nearby access point or hotspot. The search may be, for example, based on a consumer-entered street address or point of interest, and using an annotated third party map, such as Google Map, or proprietary coverage maps from one or more wireless ISPs. The potential consumer may be provided with a list of nearby hotspots and/or the corresponding operating parameters (e.g., frequency, bandwidth, compatible devices, etc.), and may select a suitable hotspot from the list as desired based on, for example, the operating parameters, a distance from a current location of the potential consumer, and/or a personal preference.

At 620, the application program may determine the location associated with the access point and/or associated retailer based on the selection by the potential consumer. The location associated with the access point may be collected by the ISP technician or the retailer and stored in a database as described above.

At 630, the application program may provide the potential consumer with directions to the access point and/or the associated retailer's facility based on, for example, the location associated with the access point for the hotspot, photos or videos of the surrounding area of the access points or the retailer's facility taken by the technician or the retailer. For example, the consumer device may include a positioning device, such as a GPS device, that may facilitate locating the consumer device as the potential consumer travels to the hotspot. Additionally or alternatively, the potential consumer may be guided through the retailer's facility based on the photos or videos of the facility taken by the technician or the retailer.

At 640, the application program may guide the potential consumer to purchase and use the Internet service. For example, the application program may guide the potential consumer to register with or log onto the wireless ISP's account or consumer authentication server, and purchase the desired service based on, for example, data rate, time of usage, data usage, etc.

In some implementations, at 650, the application program may guide the consumer to measure one or more wireless signal parameters, such as interferences from other RF sources at different frequency bands, signal strength at different locations near the access point, round-trip time (RTT) of signals traveling between the access point and the consumer device, a data communication bandwidth or date rate, latency, a data error rate, a data frame or packet drop rate, etc. For example, the consumer may measure how long it will take to load a web page or download a file of a certain size. The collected information may be uploaded to a server and be crowdsourced with information collected by other consumers or other entities (e.g., ISP technicians or retailers) for various purposes as described in the present disclosure.

It is noted that even though FIGS. 5 and 6 describe the operations as sequential processes, many of the operations can be performed in parallel or concurrently. In addition, the order of the operations may be rearranged. An operation may have additional steps not included in the figure. Some operations may be optional, and thus may be omitted in various embodiments. Some operations described in one block may be performed together with operations at another block. Furthermore, embodiments of the methods may be implemented in hardware, software, firmware, middleware, microcode, hardware description languages, or any combination thereof.

Based on the information collected by the technicians, other ISP personnel, retailers, and/or consumers, a decision may be made regarding whether an existing access point is functioning properly, whether a repair, upgrade, or replacement of one or more devices of an access point is needed, or whether and where a new access point may be installed to improve the coverage in certain areas. For example, based on the heat map generated using the RSSI information measured at different grid points in an area as shown in FIG. 4, a subarea that has no or weak coverage, such as subarea 430, may be identified as a candidate location for a new hotspot. Based on the photos, videos, and/or 3-D maps or profiles of the surrounding area, relevant information, such as obstacles (e.g., buildings or foliage) and line-of-sight coverage in the candidate location, and whether the candidate location is easily accessible or is frequently accessed, may be determined and used when determining whether and where a new access point should be installed at the candidate location. For example, for subarea 430 shown in FIG. 4, it may be determined that an access point will not be installed in the subarea because of the limited line-of-sight coverage and/or the subarea not being frequently accessed.

As described above, various general purpose or special purpose devices may be used to implement some of the methods or perform some of the operations disclosed herein. The devices may be portable (e.g., a mobile phone or a laptop computer) or stationary (e.g., a general purpose desktop computer or a server). Some devices may include some or all components for performing some or all operations disclosed herein. Some devices may be combined with one or more other devices (e.g., 3-D cameras or LIDARs) to perform some or all operations disclosed herein.

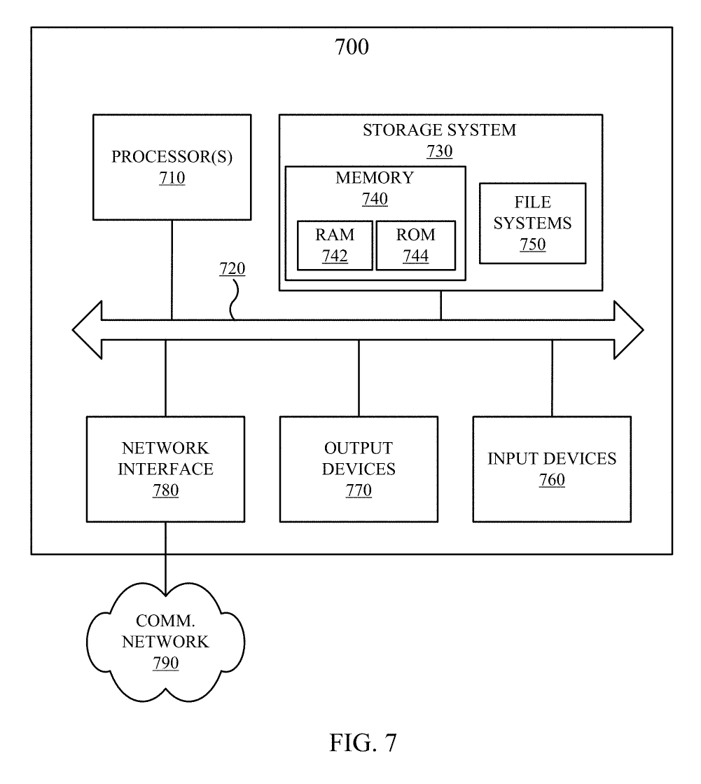

FIG. 7 is a simplified block diagram of an example computer system 700 for implementing some of the examples disclosed herein. Computer system 700 shown in FIG. 7 can be used to implement one or more of mobile device(s) 105, server(s) 160, server(s) 210, ISP device(s) 220, consumer device(s) 230, retailer device(s) 240, and mobile device 420. In this example, computer system 700 includes one or more processors 710, a bus 720, a storage system 730, one or more input devices 760, one or more output devices 770, a network interface 780, and the like.

In the present example, input device(s) 760 may include a computer mouse, a trackball, a track pad, a joystick, a wireless remote controller, a drawing tablet, a voice command system, an eye tracking system, and the like. Input device(s) 760 may allow a user to select objects, icons, text, and the like that appear on an output device 770 (e.g., a monitor or display device) via a command such as a click of a button or the like. Output devices 770 may include, without limitation, a display device (e.g., a monitor), a printer, light-emitting diodes (LEDs), speakers, and/or the like.

Examples of network interface 780 may include an Ethernet card, a modem (telephone, satellite, cable, ISDN), (asynchronous) digital subscriber line (DSL) unit, FireWire interface, universal serial bus (USB) interface, and the like. For example, network interface 780 may be coupled to a communication network 790, to a FireWire bus, or the like. In other embodiments, network interface 780 may be physically integrated on the motherboard of computer system 700, may be a software program, such as soft DSL, or the like.

Processor(s) 710 may include, without limitation, one or more general-purpose processors, one or more special-purpose processors (e.g., digital signal processing (DSP) chips, graphics acceleration processors, application-specific integrated circuits (ASICs), and/or the like), and/or other processing structures or means, which can be configured to perform one or more of the methods described herein.

Storage system 730 may include, without limitation, local and/or network accessible storage, and/or can include, without limitation, a disk drive, a drive array, an optical storage device such as a compact disk read-only memory (CD-ROM) or digital versatile disk (DVD), a solid-state storage device, which may be configured to implement any appropriate data stores, including, without limitation, various file systems 750, database structures, and/or the like. Storage system 730 may include memory 740, such as a random access memory (RAM) 742, and/or a read-only memory (ROM) 744, which can be programmable, flash-updateable, and/or the like. An operating system may be stored in file systems 750, and may be loaded to RAM 742 when computer system 700 is booted. RAM 742 and the disk drive are examples of tangible media configured to store data including executable computer code, human readable code, photos, videos, maps, and other data collected by various entities, heat maps, or the like.

In various examples, computer system 700 may also include software that enables communications over a network using, for example, the HTTP, TCP/IP, RTP/RTSP protocols, and the like. In alternative embodiments, other communications software and protocols may also be used, such as IPX, UDP, or the like.

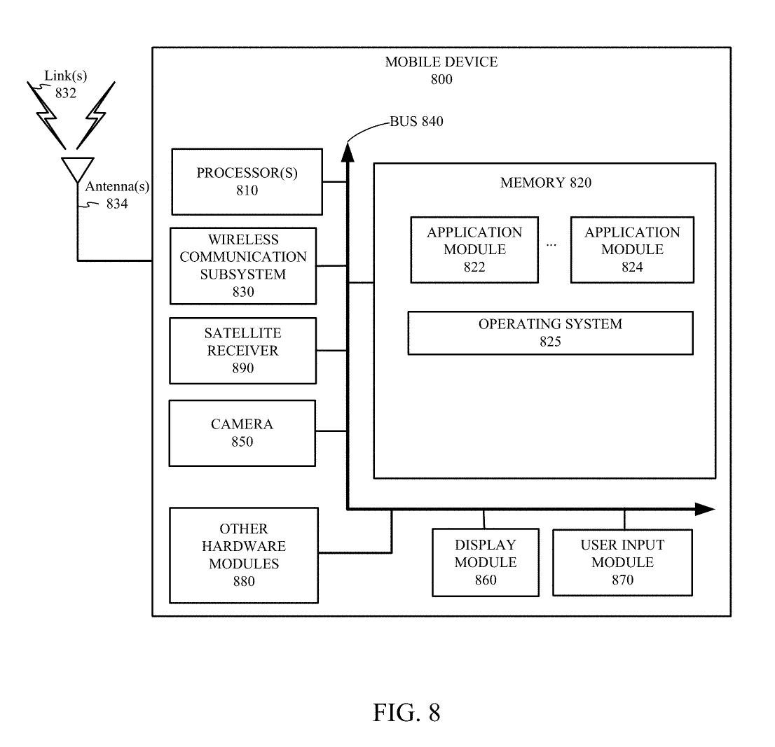

FIG. 8 is a simplified block diagram of an example mobile device 800 for implementing some of the examples disclosed herein. Mobile device 800 may be used to implement one or more of mobile device(s) 105, ISP device(s) 220, consumer device(s) 230, retailer device(s) 240, and mobile device 420. In this example, mobile device 800 may include one or more processor(s) 810 and a memory 820. Processor(s) 810 may be configured to execute instructions for performing operations at a number of components, and can be, for example, a general-purpose processor or microprocessor suitable for implementation within a portable electronic device. Processor(s) 810 may be communicatively coupled with a plurality of components within mobile device 800. To realize this communicative coupling, processor(s) 810 may communicate with the other illustrated components across a bus 840. Bus 840 may be any subsystem adapted to transfer data within mobile device 800. Bus 840 may include a plurality of computer buses and additional circuitry to transfer data.

Memory 820 may be coupled to processor(s) 810. In some embodiments, memory 820 may offer both short-term and long-term storage and may be divided into several units. Memory 820 may be volatile, such as static random access memory (SRAM) and/or dynamic random access memory (DRAM) and/or non-volatile, such as read-only memory (ROM), flash memory, and the like. Furthermore, memory 820 may include removable storage devices, such as secure digital (SD) cards. Memory 820 may provide storage of computer readable instructions, data structures, program modules, and other data for mobile device 800. In some embodiments, memory 820 may be distributed into different hardware modules. A set of instructions and/or code might be stored on memory 820. The instructions might take the form of executable code that may be executable by mobile device 800, and/or might take the form of source and/or installable code, which, upon compilation and/or installation on mobile device 800 (e.g., using any of a variety of generally available compilers, installation programs, compression/decompression utilities, etc.), may take the form of executable code.

In some embodiments, memory 820 may store a plurality of application modules 822 through 824, which may include any number of applications. Application modules 822-824 may include particular instructions to be executed by processor(s) 810. In some embodiments, certain applications or parts of application modules 822-824 may be executable by other hardware modules 880. In certain embodiments, memory 820 may additionally include secure memory, which may include additional security controls to prevent copying or other unauthorized access to secure information.

In some embodiments, memory 820 may include an operating system 825 loaded therein. Operating system 825 may be operable to initiate the execution of the instructions provided by application modules 822-824 and/or manage other hardware modules 880 as well as interfaces with a wireless communication subsystem 830 which may include one or more wireless transceivers. Operating system 825 may be adapted to perform other operations across the components of mobile device 800 including threading, resource management, data storage control and other similar functionality.

Wireless communication subsystem 830 may include, for example, an infrared communication device, a wireless communication device and/or chipset (such as a Bluetooth® device, an 802.11 device, a Wi-Fi device, a WiMax device, cellular communication facilities, etc.), and/or similar communication interfaces. Mobile device 800 may include one or more antennas 834 for wireless communication as part of wireless communication subsystem 830 or as a separate component coupled to any portion of the system. Depending on desired functionality, wireless communication subsystem 830 may include separate transceivers to communicate with base transceiver stations and other wireless devices and access points, which may include communicating with different data networks and/or network types, such as wireless wide-area networks (WWANs), WLANs, or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 830 may permit data to be exchanged with a network, other computer systems, and/or any other devices described herein. Wireless communication subsystem 830 may include a means for transmitting or receiving data, such as identifiers of mobile devices, position data, a geographic map, a heat map, photos, or videos, using antenna(s) 834 and wireless link(s) 832. Wireless communication subsystem 830, processor(s) 810, and memory 820 may together comprise at least a part of one or more of a means for performing some functions disclosed herein.

Embodiments of mobile device 800 may also include a satellite receiver 890 capable of receiving signals from one or more SPS satellites using an SPS antenna. Satellite receiver 890 may be used to determine a position of mobile device 800, using conventional techniques, from SPS satellite vehicles (SVs) of an SPS system, such as global navigation satellite system (GNSS) (e.g., GPS), Galileo, Glonass, Compass, Quasi-Zenith Satellite System (QZSS) over Japan, Indian Regional Navigational Satellite System (IRNSS) over India, Beidou over China, and/or the like. Moreover, satellite receiver 890 may use various augmentation systems (e.g., a Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein, an SPS system may include any combination of one or more global and/or regional navigation satellite systems and/or augmentation systems, and SPS signals may include SPS, SPS-like, and/or other signals associated with one or more such SPS systems.

Mobile device 800 may include a display module 860 and a user input module 870. Display module 860 may graphically present information, such as various instructions, from mobile device 800 to a user. Such information may be derived from one or more application modules 822-824, one or more other hardware modules 880, a combination thereof, or any other suitable means for resolving graphical content for the user (e.g., by operating system 825). Display module 860 may use liquid crystal display (LCD) technology, light-emitting diode (LED) technology, light emitting polymer display (LPD) technology, or some other display technology. In some embodiments, display module 860 may be a capacitive or resistive touch screen and may be sensitive to haptic and/or tactile contact with a user. In such embodiments, display module 860 may comprise a multi-touch-sensitive display. User input module 870 may include, without limitation, a touchscreen, a touch pad, microphone(s), a keyboard, a mouse, button(s), dial(s), switch(es), and/or the like.

Mobile device 800 may include a camera 850 that may be used to take photos or videos of installed devices for the access point and/or the surroundings of the access points. Camera 850 may include, for example, a complementary metal-oxide-semiconductor (CMOS) image sensor with a few millions or tens of millions of pixels. In some implementations, camera 850 may include two or more cameras that may be used to capture 3-D images.

In some embodiments, mobile device 800 may include a plurality of other hardware modules 880. Each of other hardware modules 880 may be a physical module within mobile device 800. While each of other hardware modules 880 may be permanently configured as a structure, some of other hardware modules 880 may be temporarily configured to perform specific functions or temporarily activated. Examples of other hardware modules 880 may include, for example, an accelerometer, a pressure module, a temperature module, an audio output and/or input module (e.g., a microphone), a proximity sensor, an alternate line service (ALS) module, a capacitive touch sensor, a near field communication (NFC) module, a magnetometer, a gyroscope, an inertial sensor (e.g., a module that combines an accelerometer and a gyroscope), an ambient light sensor, a relative humidity sensor, or any other similar module operable to provide sensory output and/or receive sensory input. In some embodiments, one or more functions of other hardware modules 880 may be implemented in software.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer-program product may include code and/or machine-executable instructions that may represent a procedure, a function, a subprogram, a program, a routine, an application (app), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method of providing Internet service, the method comprising:
providing, through a user interface of a mobile device, instructions for selecting one or more available devices for an access point to be installed at a geographic location;
providing, through the user interface, directions to the geographic location;
providing, through the user interface, instructions for installing and configuring the selected one or more available devices for the access point; and
providing, through the user interface, instructions for collecting information regarding the geographic location.

2. The method of claim 1, further comprising:
providing, through the user interface, instructions for saving the information regarding the geographic location to a database.

3. The method of claim 1, further comprising:
providing, through the user interface, instructions for associating the access point with a hotspot.

4. The method of claim 1, wherein providing the instructions for collecting the information regarding the geographic location comprises:
providing instructions for taking pictures of the selected one or more available devices for the access point after installing and configuring the selected one or more available devices.

5. The method of claim 1, wherein the instructions for collecting the information regarding the geographic location comprise instructions for performing at least one of:
taking one or more pictures of surroundings of the geographic location;
taking one or more videos of the surroundings of the geographic location; or
measuring a three dimensional map of the surroundings of the geographic location.

6. The method of claim 1, wherein providing the instructions for collecting the information regarding the geographic location comprises:
providing the instructions to an Internet service provider personnel or an Internet service retailer using an application or a web browser.

7. The method of claim 1, wherein providing the instructions for collecting the information regarding the geographic location comprises:
providing instructions for measuring one or more wireless signal parameters at a plurality of grid points at the geographic location.

8. The method of claim 7, wherein the one or more wireless signal parameters include at least one of a signal strength, a round trip time between a grid point and the access point, an interference level, a data transfer rate, a latency for loading a web page, a data error rate, or a packet drop rate.

9. The method of claim 7, wherein the instructions for measuring the one or more wireless signal parameters are provided to at least one of an Internet service provider personnel, an Internet service retailer, or one or more consumers.

10. The method of claim 7, further comprising:
determining at least one candidate location for setting up a new access point, based on the information regarding the geographic location.

11. The method of claim 10, wherein determining the at least one candidate location for setting up the new access point comprises:
determining the at least one candidate location for setting up the new access point based on the one or more wireless signal parameters at the plurality of grid points.

12. The method of claim 1, wherein providing the instructions for collecting the information regarding the geographic location comprises:
providing instructions to an Internet service provider personnel or an Internet service retailer for determining coordinates or an address of the geographic location.

13. The method of claim 12, further comprising:
associating the access point with a map based on the coordinates or address of the geographic location.

14. The method of claim 1, wherein the geographic location is the same as or different from a physical location of the access point.

15. A method of providing Internet service, the method comprising:
providing, through a user interface of a mobile device to a potential consumer, a list of one or more access points to the Internet;
determining a geographic location associated with an access point selected by the potential consumer from the list of one or more access points;
providing, based on information regarding the geographic location and through the user interface, directions to the geographic location, the information regarding the geographic location stored in a database; and
providing, through the user interface, instructions for purchasing Internet service at the geographic location to use the access point for accessing the Internet.

16. The method of claim 15, wherein the information regarding the geographic location comprises at least one of:
one or more pictures of surroundings of the geographic location;
one or more videos of the surroundings of the geographic location;
a three dimensional map of the surroundings of the geographic location; or
coordinates or an address of the geographic location.

17. The method of claim 15, wherein the information regarding the geographic location is collected by an Internet service provider personnel or an Internet service retailer using an application or a web browser.

18. The method of claim 15, further comprising:
providing, through the user interface, instructions for measuring one or more wireless signal parameters at a plurality of grid points at the geographic location,
wherein the one or more wireless signal parameters comprise at least one of a signal strength, a signal round trip time between a grid point and the selected access point, an interference level, a data transfer rate, a latency for loading a web page, a data error rate, or a packet drop rate.

19. A system comprising:
one or more processors;
a user interface; and
a non-transitory computer-readable medium storing instructions that, when executed by the one or more processors, cause the one or more processors to perform operations including:
providing, through the user interface, instructions for selecting one or more available devices for an access point at a geographic location;
providing, through the user interface, directions to the geographic location;
providing, through the user interface, instructions for installing and configuring the selected one or more available devices for the access point; and
providing, through the user interface, instructions for collecting information regarding the geographic location.

20. The system of claim 19, wherein the information regarding the geographic location comprises at least one of:
one or more pictures of surroundings of the geographic location;
one or more videos of the surroundings of the geographic location;
a three dimensional map of the surroundings of the geographic location;
coordinates or an address of the geographic location; or
one or more wireless signal parameters at a plurality of grid points at the geographic location.
